(19) United States
(12) Patent Application Publication
(10) Pub. No.: US 2003/0002110 A1
(43) Pub. Date: Jan. 2, 2003

(54) RF level stabilization of optical link over temperature

(75) Inventors: Marcel F.C. Schemmann, Echt (NL); Venkatesh G. Mutalik, Manlius, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/896,211

(22) Filed: Jun. 29, 2001

(51) Int. Cl. H04B 10/08; H04B 10/00

(52) U.S. Cl. 359/154; 359/110

(57) ABSTRACT

A radio frequency stabilization system (e.g., for use with a laser transmitter) in an optical communication system is provided. The present invention relates to maintaining a stable RF level in an optical link despite temperature fluctuations, including a transmitter section, a receiver section, a plurality of feedback loops connected to each of the transmitter section and the receiver section. The present invention further discloses a method of stabilizing an RF level in an optical link which method include providing an optical signal transmitter, an optical signal receiver, and a plurality of feedback loops to the optical transmitter section and the optical receiver section.

### BACKGROUND OF THE INVENTION

1. Technical Field

The present invention relates generally to an optical link and more specifically to stabilization of the radio frequency (RF) level of the optical link. A method is also disclosed for utilizing the disclosed system for stabilization of the radio frequency (RF) level of the optical link.

2. Related Art

It is well known that the efficiency of a laser drops over temperature. It is also known that there exists a tracking error that prevents an exact track of the output levels of the laser over temperature. Due to a combination of these two factors, it is observable that the radio frequency (RF) level of an optical level changes significantly over temperature. The above issue affects the modulation depth that is perceived by the laser, which results in the same RF power affecting the laser and inducing certain extra noise conditions such as Rayleigh noise, etc., under certain conditions.

In a typical optical link, such as, inter alia, that found in a cable television (CATV) transmission system having a transmitter section and a receiver section, the RF level in the transmitted signal will vary with four parameters, namely, the laser temperature; the transmission link distance; the RF input changes to the transmitter section; and the overall transmission system gain.

The RF level at the receiver section will depend mainly on only two parameters, the optical modulation index (OMI) of the laser; and the optical power at the receiver section. However, to a lesser extent, the RF level also depends on the receiver section sensitivity, which changes from wavelength to wavelength; and the matching gain, which is an RF design issue.

### SUMMARY OF THE INVENTION

It is therefore a feature of the present invention to overcome the above shortcomings related to optical links by providing a novel apparatus and method for maintaining the RF level stability over an optical link regardless of the temperature variation.

The present invention seeks to reduce the RF level stabilization over temperature utilizing two concepts. First, on the transmitter section end, the invention seeks to maintain the product of the optical modulation depth and the output power constant. On the receiver section end, appropriate circuitry is utilized to pick up and restore any RF level that was not maintained at the transmitter section.

The invention relies on the realization that the product of the laser OMI and the output power impacts the RF level. Accordingly, on the transmitter section side, a sub-5 Mhz carrier is impressed prior to the laser. This modulation is then simultaneously picked up by the laser rear face photo diode monitor and the receiver photo diode. The invention then maintains the RF level of the optical link constant by a combination of control of both the transmitter section front end and the receiver section front end. The advantage of the above procedure is that it monitors the RF level independent of loading on the transmitter, significantly reduces Rayleigh noise in sparsely loaded return systems, and provides mechanics to control the RF level on both the receiver and transmitter ends which is essential to maintaining the optical link below clipping behavior.

The present invention uses three feedback loops in the transmitter section and two feedback loops in the receiver section to both change, when necessary, and maintain at a particular level, RF levels related to an optically transmitted signal. The present invention further allows the following six functions may be performed simultaneously:

1. Preserve or change OMI;

2. Maintain output power;

3. Compensate for temperature changes;

4. Compensate for laser or system tracking errors

5. Provide gain at the right place, that is, in the transmitter section or the receiver section, as needed; and

6. Provide for RF input changes.

Finally, the apparatus and method of the present invention may also be used for any laser system, and in particular for Dynamic Noise-power-ratio (NPR) Boost (DNB) or enhancement as disclosed in related US patent application no.(later), filed July, 2001, and incorporated herein by reference.

In a first general aspect, the present invention provides an apparatus for maintaining a stable RF level in an optical link, said apparatus comprising: a transmitter section; a receiver section; a plurality of feedback loops operationally connected to said transmitter section; and a plurality of feedback loops operationally connected to said receiver section.

In a second general aspect, the present invention provides a method of stabilizing an RF level in an optical link, said method comprising: providing an optical signal transmitter section; providing an optical signal receiver section; providing a plurality of feedback loops to said optical signal transmitter section; and providing a plurality of feedback loops to said optical signal receiver section.

In a third general aspect, the present invention provides an optical transmission system comprising: an optical signal transmitter section; an optical signal receiver section; an RF stabilization system operationally connected to said optical signal transmitter section; and an RF stabilization system operationally connected to said optical signal receiver section.

The foregoing and other features and advantages of the invention will be apparent from the following more particular description of embodiments of the invention.

### BRIEF DESCRIPTION OF THE DRAWINGS

The features and inventive aspects of the present invention will become more apparent upon reading the following detailed description, claims, and drawings, of which the following is a brief description.

FIG. 1 is a block diagram representation of a current stabilization system according to an embodiment of the related art.

FIG. 2 is a block diagram representation of a basic RF level stabilization system according to an embodiment of the present invention.

FIG. 3 is a block diagram representation of an enhanced RF level stabilization system according to an embodiment of the present invention.

FIG. 4 is a block diagram representation of a full RF level stabilization system according to an embodiment of the present invention.

FIG. 5 is a block diagram representation of a functional RF level stabilization system according to an embodiment of the present invention.

### DETAILED DESCRIPTION OF THE EMBODIMENTS

The following is a detailed explanation, with reference to the attached drawings, of the apparatus for RF level stabilization of an optical link over temperature variations, and a method for using the apparatus for RF level stabilization of an optical link over temperature variations, in embodiments of the present invention. It should be noted that the same reference numbers are assigned to components having approximately the same functions and structural features in the following explanation and the attached drawings to preclude the necessity for repeated explanation thereof.

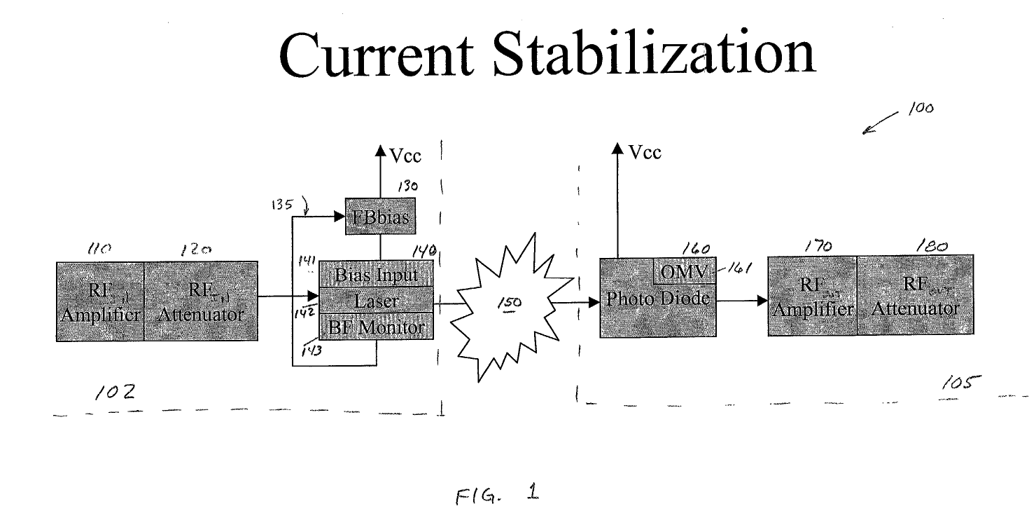

FIG. 1 shows a block diagram representation of a current stabilization system 100 for an optical link according to an embodiment of the related art. Current stabilization system 100 includes a transmitter section 102, an optical link 150, and a receiver section 105. Transmitter section 102 includes an RF path comprising RF_{IN} amplifier circuit 110 and RF_{IN} attenuator circuit 120, which are coupled to a laser transmitter 140. Laser transmitter 140 is powered by supply voltage V_{cc}, and includes a laser device (e.g., a laser diode) 142, a bias input circuit 141, and a back facet (BF) monitor circuit 143. A first transmitter feedback loop 135 provides a bias current feedback signal 130 from BF monitor circuit 143 signal to the bias input circuit 141. The bias current feedback bias signal 130 derived from the back facet monitor circuit 143 represents the DC current range of the laser device 142.

The output signal from the laser device 142 is carried over optical link 150, and is received by receiver section 105. Receiver section 105 includes photo diode circuit 160, which is controlled by optical modulation voltage (OMV) control circuit 161, and powered by supply voltage V_{cc}. The output of photo diode circuit 160 is coupled to an RF path comprising RF_{OUT} amplifier circuit 170 and RF_{OUT} attenuator circuit 180.

Optical link 150 may be comprised of, inter alia, erbium doped fiber amplifiers (EDFAS), semiconductor optical amplifiers (SOA's), and various kinds of optical fiber, such as, inter alia, single mode fiber (SMF) or dispersion compensating fiber (DCF).

An inherent drawback in the related art current stabilization system 100, is that this current stabilization system 100 cannot compensate for two well known phenomenon, namely that the efficiency of a laser drops as temperature rises, and that tracking errors exist which prevent an exact tracking of the output level of the laser as the temperature varies.

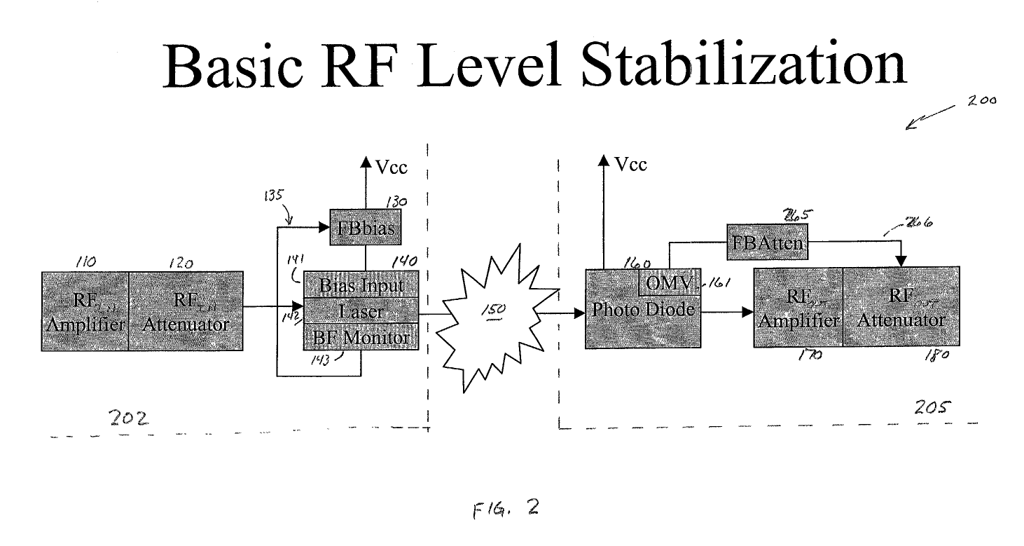

Referring now to FIG. 2, a block diagram representation of a basic RF_{IN} level stabilization system 200 according to an embodiment of the present invention. Basic RF_{IN} level stabilization system 200 includes a transmitter section 202, an optical link 150, and a receiver section 205. Transmitter section 202 is similar to transmitter section 102 of the current stabilization system 100 of FIG. 1. Receiver section 205 is similar to receiver section 105 of the current stabilization system 100 of FIG. 1, except that receiver section 205 includes an added first receiver feedback loop 266.

First receiver feedback loop 266 provides a feedback signal from the optical modulation voltage (OMV) control circuit 161 to the RF_{OUT} attenuator circuit 180. The optical modulation voltage (OMV) control circuit 161 produces an feedback signal which is proportional to changes in the optical level of the photo diode 160. First receiver feedback loop 266 includes a feedback attenuation circuit 265 to scale the feedback signal to a level compatible with RF_{OUT} attenuator circuit 180.

This embodiment (FIG. 2) compensates for changes in the optical power, including the tracking error. However, this embodiment cannot accommodate changes in the optical modulation index caused by changes in laser efficiency.

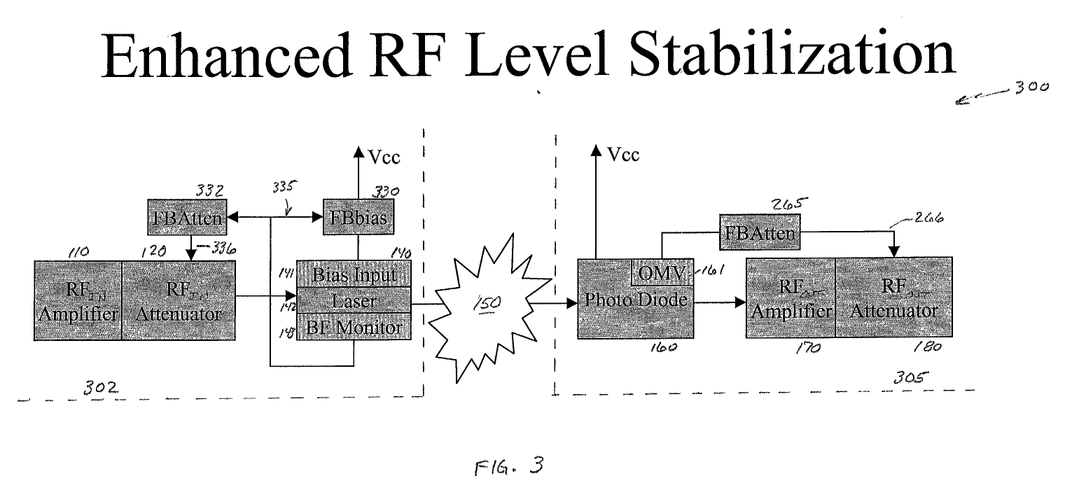

FIG. 3 is a block diagram representation of an enhanced RF level stabilization system according to an embodiment of the present invention. Enhanced RF level stabilization system 300 includes a transmitter section 302, an optical link 150, and a receiver section 305. Transmitter section 302 is similar to transmitter section 102 of the basic RF level stabilization system 200 of FIG. 2, except that transmitter section 302 includes an added second transmitter feedback loop 336. Receiver section 305 is similar to receiver section 205 of the basic RF level stabilization system 200 of FIG. 2.

Second transmitter feedback loop 336 provides a feedback attenuation circuit 332 from the back facet monitor 143 to the RF_{IN} attenuator circuit 120. The feedback attenuation circuit 332 produces an attenuated feedback signal which is proportional to the bias current from the laser. Second transmitter feedback loop 336 includes a feedback attenuation circuit 332 to scale the feedback signal to a level compatible with RF_{OUT} attenuator circuit 180. Feedback attenuation circuit 332 may include a diode, transistor, or other attenuation circuit (e.g., a PIN transistor circuit).

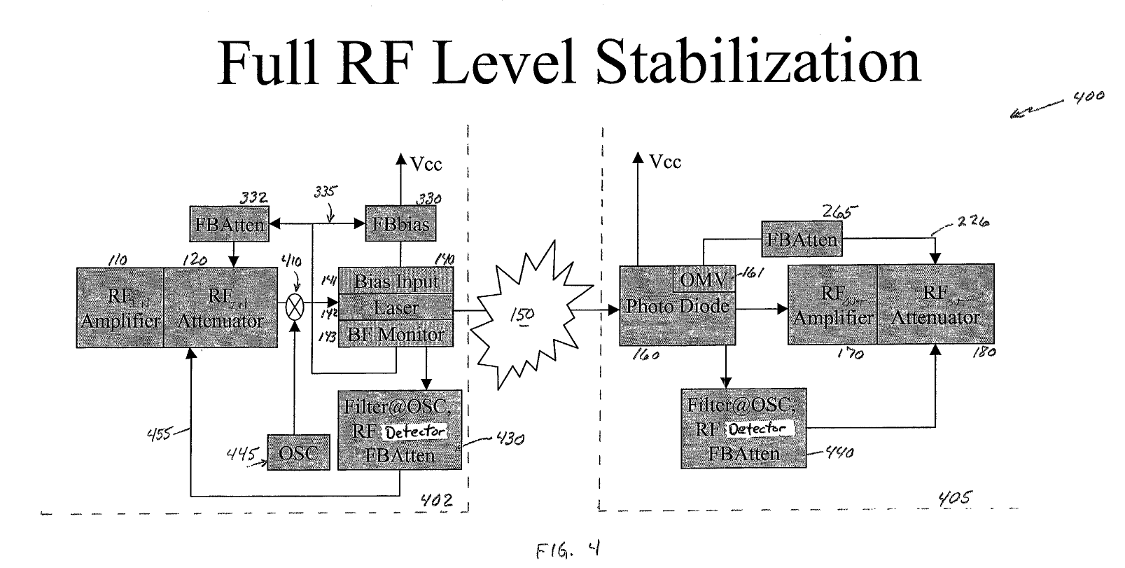

FIG. 4 is a block diagram representation of a full RF level stabilization system according to an embodiment of the present invention. Full RF level stabilization system 400 includes a transmitter section 402, an optical link 150, and a receiver section 405. Transmitter section 402 is similar to transmitter section 302 of the enhanced RF level stabilization system 300 of FIG. 3, except that two additions have been made. First, an oscillator circuit 445 has been added to the output of the RF attenuator 120. Oscillator circuit 445 introduces a signal tone of e.g., 100 kHz or thereabouts. Second, a third transmitter feedback circuit 430 has been added which provides a feedback loop from the back facet monitor 430 to the RF attenuator 120.

Third transmitter feedback loop 455 provides a feedback signal from the back facet monitor 143 to the RF_{IN} attenuator 120. Third transmitter feedback loop 455 includes a filter oscillator circuit, an RF detector circuit, and a feedback attenuator circuit. The RF in the transmitted signal is sensed by the RF detector circuit of feedback circuit 430 and is then fed to the feedback attenuator circuit which reduces or increases attenuation as needed.

Receiver section 405 is similar to receiver section 305 of the enhanced RF level stabilization system 300 of FIG. 3, except that receiver section 405 includes an added second receiver feedback circuit 440 which provides a feedback loop from the photo diode 160 to the RF_{OUT} attenuator 180. A signal from photo diode circuit 160 is fed to second receiver feedback circuit 440 which includes a filter oscillator circuit, an RF_{IN} sensor circuit, and a feedback attenuator circuit. The RF in the received signal is sensed by the RF detector circuit of second receiver feedback circuit 440 and is then fed to the feedback attenuator circuit which reduces or increases attenuation as needed.

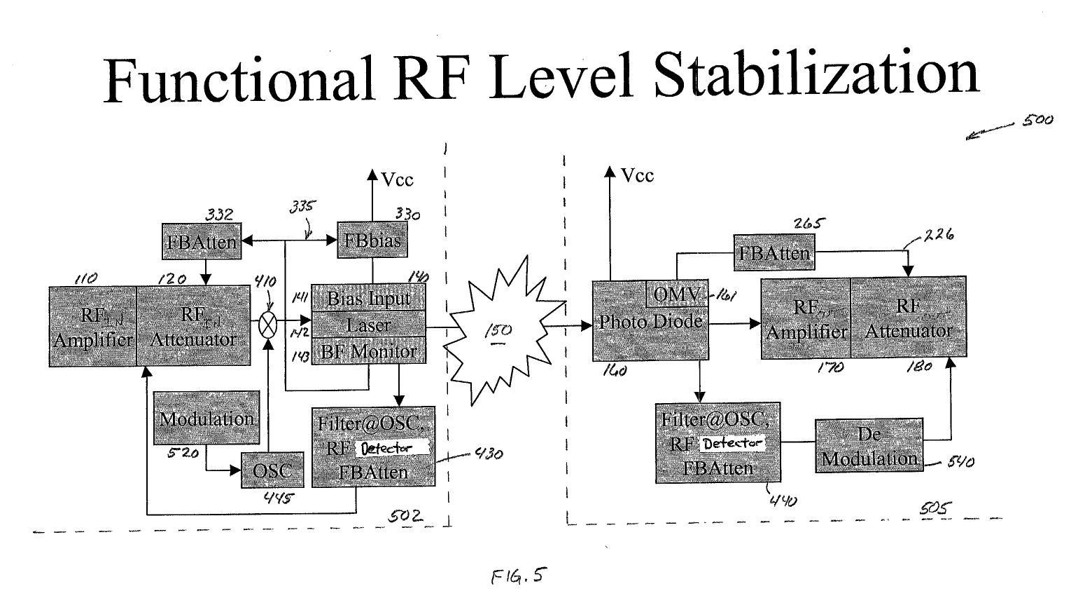

FIG. 5 is a block diagram representation of a functional RF level stabilization system according to an embodiment of the present invention. Functional RF level stabilization system 500 includes a transmitter section 502, an optical link 150, and a receiver section 505. Transmitter section 502 is similar to transmitter section 402 of the full RF level stabilization system 400 of FIG. 4, except that modulation and demodulation circuits have been added to the transmitter section 502 and the receiver section 505, respectively.

The modulation circuit 520 coupled to the oscillator circuit 445 of the transmitter section 502 enables the output signal from oscillator circuit 445 to be selectively varied, which in turn will selectively vary the output at node 410 of the RF_{IN} attenuator circuit 120. This operation effectively tunes the output of the RF_{IN} attenuator circuit 120, and hence the laser device 142.

Similarly, the demodulation circuit 540 in receiver section 505 provides demodulation of the feedback circuit 440.

Embodiments of the present invention have been disclosed. A person of ordinary skill in the art would realize, however, that certain modifications would come within the teachings of this invention. Therefore, the following claims should be studied to determine the true scope and content of the invention.

What is claimed is:

1. An apparatus for maintaining a stable RF level in an optical link, said apparatus comprising:
a transmitter section;
a receiver section;
a plurality of feedback loops operationally connected to said transmitter section; and
a plurality of feedback loops operationally connected to said receiver section.

2. The apparatus of claim 1, wherein the feedback loops perform at least one function selected from the group consisting of:
i. RF level stabilization effects;
ii. preserve or change optical modulation index (OMI);
iii. adjust output power;
iv. compensate for temperature changes;
v. compensate for laser or system tracking errors;
vi. provide gain at proper places in circuitry; and
vii. provide RF input changes.

3. The apparatus of claim 2, wherein the feedback loops operationally connected to said transmitter section include a first, second, and third transmitter section feedback loops.

4. The apparatus of claim 2, wherein the feedback loops operationally connected to said receiver section include a first and second receiver section feedback loops.

5. The apparatus of claim 3, wherein the first transmitter feedback loop is a constant power feedback loop.

6. The apparatus of claim 3, wherein the second transmitter feedback loop is a bias current feedback loop connected between the transmitter section and an attenuation circuit in an RF path.

7. The apparatus of claim 5, wherein the attenuation circuit is a PIN transistor circuit.

8. The apparatus of claim 3, wherein the second transmitter feedback loop is a bias current feedback loop.

9. The apparatus of claim 3, wherein the third transmitter feedback loop provides an RF level from a back facet monitor.

10. The apparatus of claim 9, further including an oscillator operationally connected to said third transmitter feedback loop.

11. The apparatus of claim 10, wherein said oscillator is characterized by an operational frequency of about 100 kHz.

12. The apparatus of claim 10, wherein said oscillator has an output signal, said output signal coupled to an input of an RF detector, said RF detector having an attenuating output proportional to said input, and said attenuating output coupled to the attenuation circuit.

13. The apparatus of claim 4, wherein the first receiver feedback loop is an optical modulation voltage (OMV) feedback loop, said optical modulation voltage feedback loop connected to RF circuitry in said receiver section.

14. The apparatus of claim 4, wherein the second receiver feedback loop is an oscillator signal feedback loop, said oscillator feedback loop connected to RF circuitry in said receiver section.

15. The apparatus of claim 14, wherein said oscillator feedback loop includes an oscillator tuned to a frequency of about 100 kHz.

16. The apparatus of claim 14, wherein said oscillator feedback loop includes a device to modulate said oscillator feedback.

17. A method of stabilizing an RF level in an optical link, said method comprising:
providing an optical signal transmitter section;
providing an optical signal receiver section;
providing a plurality of feedback loops to said optical signal transmitter section; and
providing a plurality of feedback loops to said optical signal receiver section.

18. The method of claim 17, wherein the feedback loops perform at least one function selected from the group consisting of:
i. RF level stabilization effects;
ii. preserve or change optical modulation index (OMI);
iii. adjust output power;
iv. compensate for temperature changes;
v. compensate for laser or system tracking errors;
vi. provide gain at proper places in circuitry; and
vii. provide RF input changes.

19. The method of claim 17, wherein the feedback loops operationally connected to said transmitter section include a first, second, and third transmitter feedback loops.

20. The method of claim 17, wherein the feedback loops operationally connected to said receiver section include a first and second receiver feedback loops.

21. The method of claim 18, wherein the first transmitter feedback loop is a constant power feedback loop.

22. The method of claim 18, wherein the second transmitter feedback loop is a bias current feedback loop connected between the transmitter section and an attenuation circuit in an RF path.

23. The method of claim 21, wherein the attenuation circuit is a PIN transistor circuit.

24. The method of claim 18, wherein the second transmitter feedback loop is a bias current feedback loop.

25. The method of claim 18, wherein the third transmitter feedback loop provides an RF level from a back facet monitor.

26. The method of claim 24, further including an oscillator operationally connected to said third transmitter feedback loop.

27. The method of claim 25, wherein said oscillator is characterized by an operational frequency of about 100 kHz.

28. The method of claim 25, wherein said oscillator has an output signal, said output signal coupled to an input of an RF detector, said RF detector having an attenuating output proportional to said input, and said attenuating output coupled to the attenuation circuit.

29. The method of claim 19, wherein the first receiver feedback loop is an optical modulation voltage (OMV) feedback loop, said optical modulation voltage feedback loop connected to RF circuitry in said receiver section.

30. The method of claim 19, wherein the second receiver feedback loop is an oscillator signal feedback loop, said oscillator feedback loop connected to RF circuitry in said receiver section.

31. The method of claim 29, wherein said oscillator feedback loop includes an oscillator tuned to a frequency of about 100 kHz.

32. The method of claim 29, wherein said oscillator feedback loop includes a device to modulate said oscillator feedback.

33. An optical transmission system comprising:
an optical signal transmitter section;
an optical signal receiver section;
an RF stabilization system operationally connected to said optical signal transmitter section; and
an RF stabilization system operationally connected to said optical signal receiver section.

34. The optical transmission system of claim 33, wherein the optical transmission system is a cable television (CATV) system.
